(19) United States
(12) Patent Application Publication
(10) Pub. No.: US 2006/0248015 A1
(43) Pub. Date: Nov. 2, 2006

(54) Adjusting billing rates based on resource use

(75) Inventors: Randall Paul Baartman, Rochester, MN (US); Matthew Ara Goshgarian, Rochester, MN (US); Thomas Bradley Kochie, Rochester, MN (US); Robert Wisniewski, Rochester, MN (US)

Correspondence Address: Robert R. Williams;IBM Corporation, Dept. 917, 3605 Highway 52 North, Rochester, MN, 55901-7829, US

(73) Assignee: INTERNATIONAL BUSINESS MACHINES CORPORATION, ARMONKE, NY (US)

(21) Appl. No.: 11/116,622

(22) Filed: Apr. 28, 2005

(51) Int. Cl. G06Q 99/00

(52) U.S. Cl. 705/52

(57) ABSTRACT

A method, apparatus, system, and signal-bearing medium that, in an embodiment, adjust a billing rate for the use of a resource by processes based on usage data that indicates the demand for the resource either by one of the processes or by an aggregation of the processes. In an embodiment, the resource has a resource threshold, a resource billing rate, and a billing rate increment, and the aggregation of the processes has an associated system threshold and a system billing rate. In an embodiment the billing rate is incremented by the billing rate increment if an amount of use by one process exceeds the resource threshold and the number of processes exceeds a threshold. In an embodiment, if the aggregation of the processes uses the resource more than the system threshold, then the resource billing rate is set to be the system billing rate. In this way, the demand for resources may be accounted for in billing for resource use.

### FIELD

An embodiment of the invention generally relates to computers. In particular, an embodiment of the invention generally relates to adjusting billing rates based on resource use in a computer.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

One use of high performance computer systems is an on-demand computing environment, where multiple processes (e.g., partitions, applications, or application servers) use resources of the computer (e.g., processors, memory, storage, etc.) to provide services to users. Because the computing environment is on-demand, the use of the resources can change dramatically over time, where at certain times the processes may use a great deal of the computer's resources while at other times the processes may use relatively little of the resources. In some environments, the resources are scalable, so that additional resources (or entire additional computers) may be added when demand is greater and removed when demand is less. But, in other environments, the resources are fixed, and the processes compete with each other for scarce resources.

Because the computer resources (whether scalable or fixed) are important and costly, administrators of the computer want to carefully track the use of the resources in order to bill the processes for using the resources. This billing may be in the form of actual money that one company pays to another or may be merely an accounting or budgeting charge between different departments of the same company, so that, e.g., an IT (Information Technology) department may justify purchasing additional resources or demonstrate that the company is making good use of existing resources.

Unfortunately, current billing schemes for resources use a fixed pricing strategy, which does not take into account the change in value of the resources as the demand for the resources change over time in an on-demand environment. Hence, a better way is needed to bill for the use of resources, in order to obtain a more accurate measure of the value of the resources.

### SUMMARY

A method, apparatus, system, and signal-bearing medium are provided that, in an embodiment, adjust a billing rate for the use of a resource by processes based on usage data that indicates the demand for the resource either by one of the processes or by an aggregation of the processes. In an embodiment, the resource has a resource threshold, a resource billing rate, and a billing rate increment, and the aggregation of the processes has an associated system threshold and a system billing rate. In an embodiment the billing rate is incremented by the billing rate increment if an amount of use by one process exceeds the resource threshold and the number of processes exceeds a threshold. In an embodiment, if the aggregation of the processes uses the resource more than the system threshold, then the resource billing rate is set to be the system billing rate. In this way, the demand for resources may be accounted for in billing for resource use.

### BRIEF DESCRIPTION OF THE DRAWING

Various embodiments of the present invention are hereinafter described in conjunction with the appended drawings:

FIG. 1 depicts a block diagram of an example system for implementing an embodiment of the invention.

FIG. 2A depicts a block diagram of an example data structure for usage data, according to an embodiment of the invention.

FIG. 2B depicts a block diagram of an example data structure for resource data, according to an embodiment of the invention.

FIG. 2C depicts a block diagram of an example data structure for system data, according to an embodiment of the invention.

FIG. 3 depicts a flowchart of example processing for adjusting billing rates based on system use of resources, according to an embodiment of the invention.

FIG. 4 depicts a flowchart of example processing for adjusting billing rates based on use of a resource by processes, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

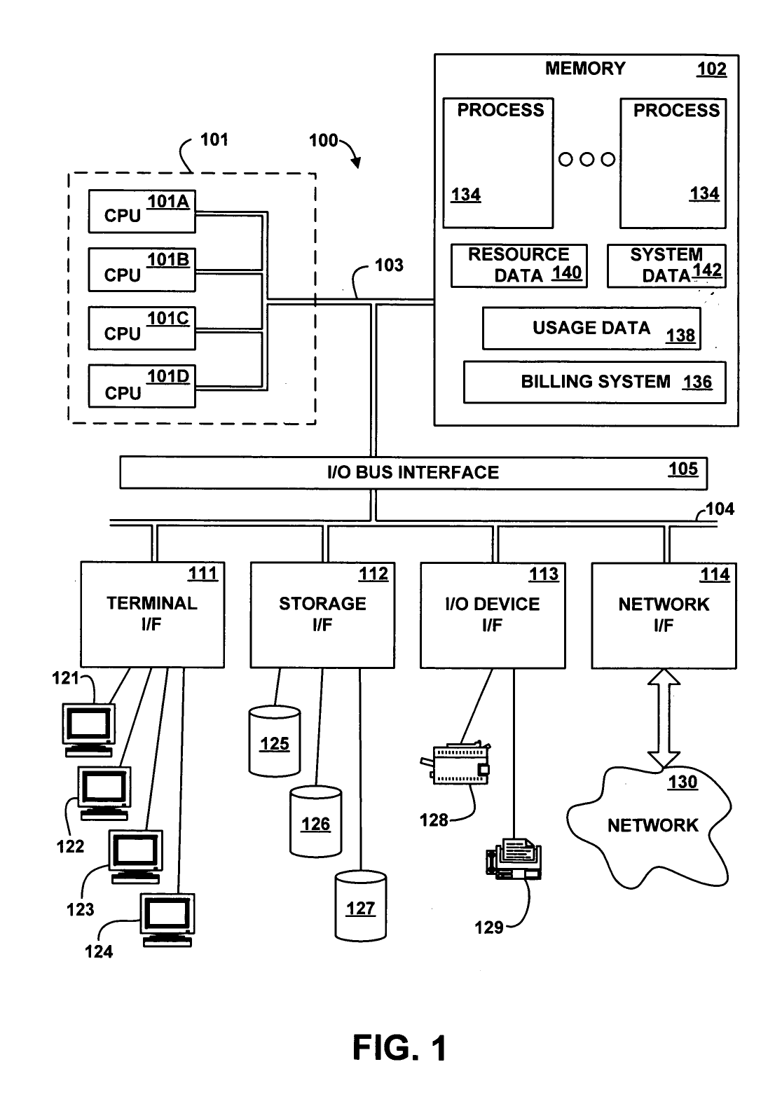

Referring to the Drawings, wherein like numbers denote like parts throughout the several views, FIG. 1 depicts a high-level block diagram representation of a computer system 100 connected to a network 130, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as a processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes a number of processes 134, a billing system 136, usage data 138, resource data 140, and system data 142. Although the processes 134, the billing system 136, the usage data 138, the resource data 140, and the system data 142 are illustrated as being contained within the memory 102 in the computer system 100, in other embodiments some or all of them may be on different computer systems or other electronic devices accessed remotely, e.g., via the network 130. Further, the computer system 100 may use virtual addressing mechanisms that allow the programs of the computer system 100 to behave as if they only have access to a large, single storage entity instead of access to multiple, smaller storage entities. Thus, while the processes 134, the billing system 136, the usage data 138, the resource data 140, and the system data 142 are illustrated as residing in the memory 102 in the computer 100, these elements are not necessarily all completely contained in the same storage device, or in the same computer, at the same time. Although the billing system 136, the usage data 138, the resource data 140, and the system data 142 are illustrated as being separate entities, in other embodiments some or all of them may be packaged together.

In various embodiments, the processes 134 may be applications, application servers, partitions managed by a hypervisor or partition manager to provide a logically-partitioned computer, or any other appropriate type of process. An application may be any form of executable or interpretable code, whether part of an operating system, written by a user, who provided by a third party. An application server is an application environment, often referred to as middleware, that provides services to applications that make writing the applications easier. The services may include, e.g., database management systems, library and search services, mail services, or any other appropriate type of services. The processes 134 may perform services in response to requests from the network 130, the terminal interface 111, and/or from any other appropriate source. A logical partition is a virtual computer system and typically includes one or more applications and an operating system. Each logical partition executes in a separate, or independent memory space and acts much the same as an independent non-partitioned computer from the perspective of its applications and operating system.

Each of the processes 134 may be allocated a portion of the available resources in computer 100. For example, each process 134 may be allocated one or more of the processors 101 and/or one or more hardware threads, as well as a portion of the available memory space of the memory 102. The processes 134 may share specific software and/or hardware resources such as the processors 101, such that a given resource may be utilized by more than one process 134. In the alternative, software and hardware resources can be allocated to only one process 134 at a time. Additional resources, e.g., mass storage, backup storage, user input, network connections, and the I/O adapters therefor, are typically allocated to one or more of the processes 134. Resources may be allocated in a number of manners, e.g., on a bus-by-bus basis, or on a resource-by-resource basis, with multiple processes 134 sharing resources on the same bus. Some resources may even be allocated to multiple processes 134 at a time. The resources identified herein are examples only, and any appropriate resource capable of being allocated may be used.

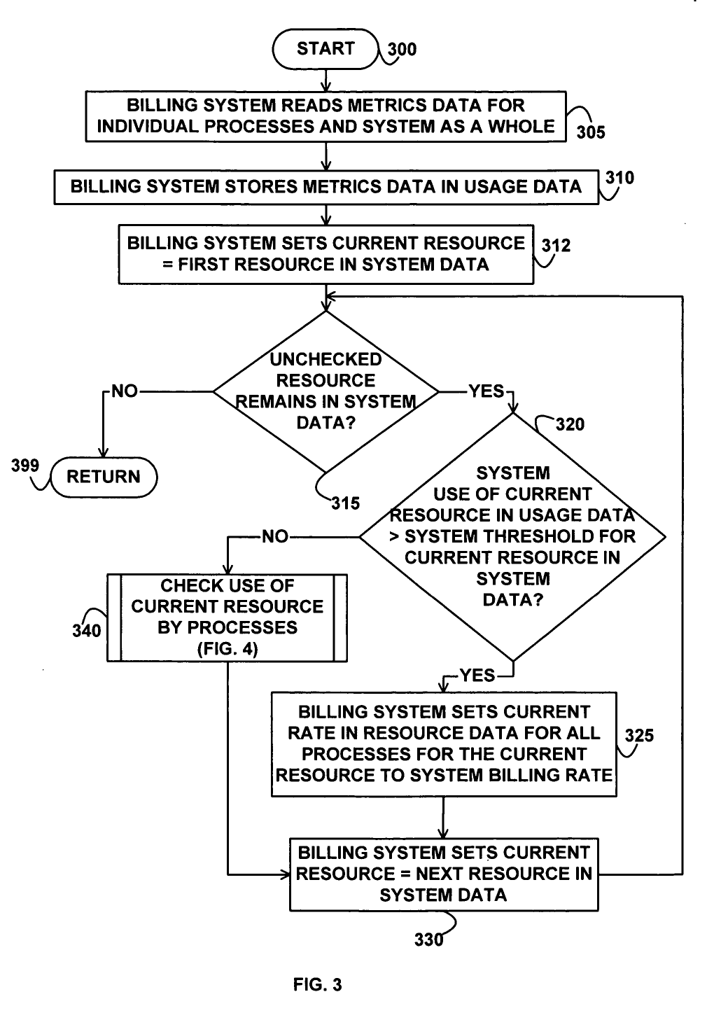

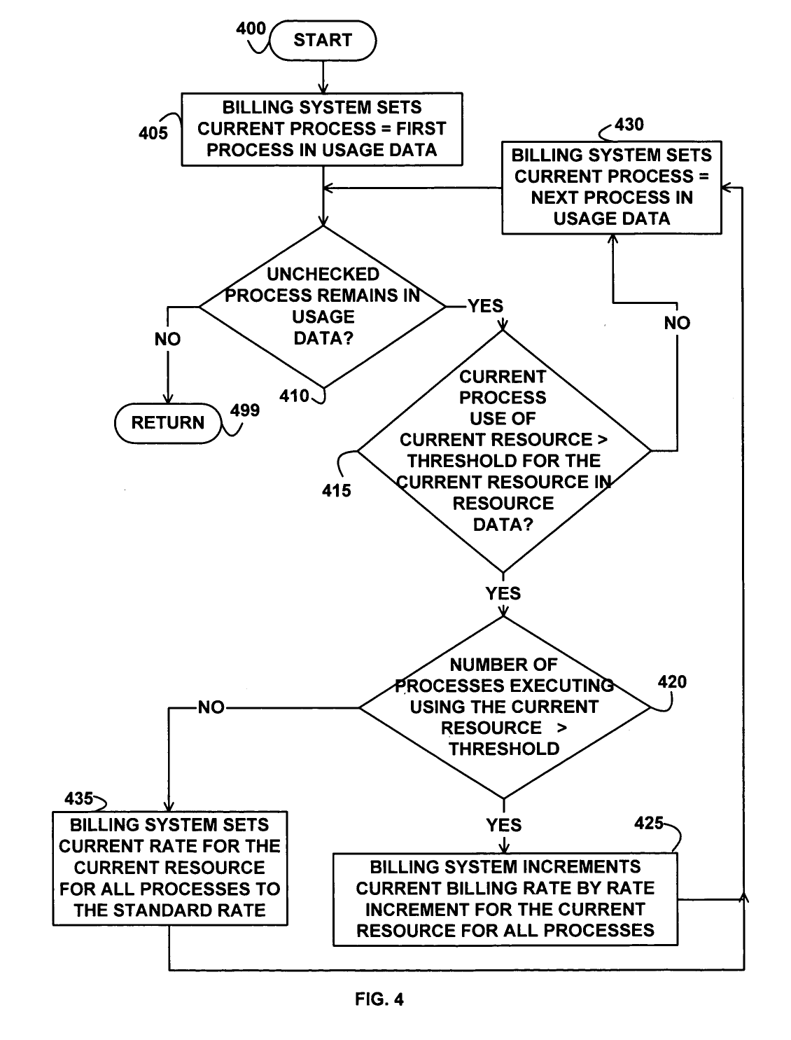

The billing system 136 uses the usage data 138, the resource data 140, and the system data 142 to adjust billing rates for the use of the resources of the computer system 100 by the processes 134. In an embodiment, the billing system 136 includes instructions capable of executing on the processor 101 or statements capable of being interpreted by instructions executing on the processor 101 to perform the functions as further described below with reference to FIGS. 3 and 4. In another embodiment, the billing system 136 may be implemented in microcode or firmware. In another embodiment, the billing system 136 may be implemented in hardware via logic gates and/or other appropriate hardware techniques. Although the billing system 136 is illustrated as being separate from the processes 134, in another embodiment the billing system 136 may be implemented as one of the processes 134 or may be a part of one of the processes 134.

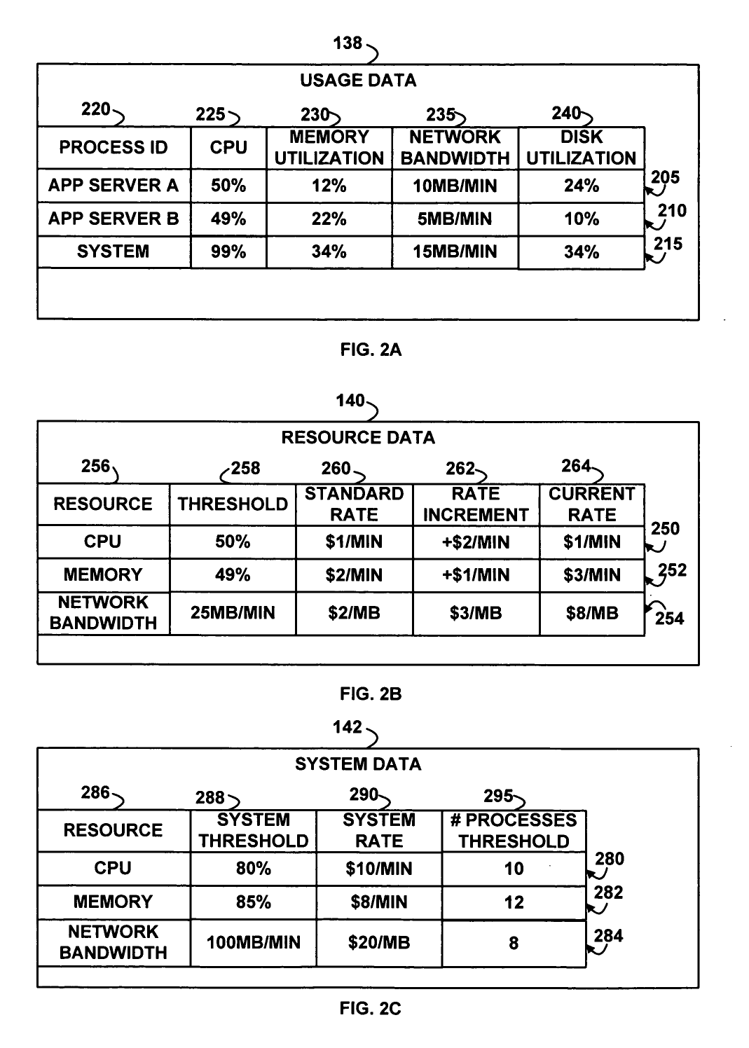

The usage data 138 describes a history of the use of the resources by the processes 134. The usage data 138 is further described below with reference to FIG. 2A. The resource data 140 describes criteria for setting rates for use of the resources based on use of the resources by the processes 134. The resource data 140 is further described below with reference to FIG. 2B. The system data 142 describes criteria for setting rates for use of the resources based on use of the resources by the computer system 101 as a whole. The system data 142 is further described below with reference to FIG. 2C. Although the usage data 138, the resource data 140, and the system data 142 are illustrated as being separate from the processes 134, in another embodiment some or all of them exist as portions of one or more of the processes 134.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

It should be understood that FIG. 1 is intended to depict the representative major components of the computer system 100 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications medium, such as through a computer or a telephone network, e.g., the network 130, including wireless communications.

Such signal-bearing media, when carrying machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2A depicts a block diagram of an example data structure for the usage data 138, according to an embodiment of the invention. The usage data 138 includes records 205, 210, and 215, but in other embodiments any number of records with any appropriate data may be present. Each of the records 205, 210, and 215 includes a process identifier field 220, a CPU utilization field 225, a memory utilization field 230, a network bandwidth field 235, and a disk utilization field 240, but in other embodiments more or fewer fields may be present. The process identifier field 220 identifies one or more of the processes 134 in the computer system 100 or accessed via the network 130, such as in the example records 205 and 210, or may also identify the entire system including an aggregation of all of the processes 134, such as in the example record 215. The CPU utilization field 225 indicates the utilization of the processor 101 by the associated process 220. The memory utilization field 230 indicates the utilization of the memory 102 by the associated process 220. The network bandwidth field 235 indicates the amount of data transferred across the network 130 by the associated process 220.

The disk utilization field 240 indicates the utilization of the disks 125, 126, and/or 127 by the associated process 220. In various embodiments, the disk utilization 240 may be characterized in any appropriate way. For example, in an embodiment, the disk utilization 240 is expressed as an amount of static disk real estate used by the binary executable file and associated supporting files (e.g., configuration files) of the process 220 regardless of whether the process 220 is executing or not. In another embodiment, the disk utilization 240 may be expressed as an amount of dynamic disk real estate used by the process 220. The amount of disk real estate used by the process 220 can vary, depending on whether the process 220 is executing. For example, when not running, data previously stored on the disk by the process 220 may be one amount. But, when the process 220 is running, it may temporarily use additional storage to maintain information about the current state of the process 220 plus temporary data not yet committed to the disk in the form of a file system or database system. In yet another embodiment, the disk utilization 240 may be expressed as the rate at which disk real estate is read from or written to. For example, the process 220 may read or write persistent or temporary disk file system real estate. This activity may be sporadic, or it may be constant, so the data points are rate and time duration.

The CPU utilization field 225, the memory utilization field 230, the network bandwidth field 235, and the disk utilization field 240, are examples of metrics that indicate the use of resources of the computer system 100 by the processes 134′, but in other embodiments any appropriate metrics of any appropriate resources may be used. For example, in other embodiments, metrics reflecting the use of printers, numbers of disk I/O operations, use of any I/O device, or any other appropriate metrics for any appropriate resource may be used.

FIG. 2B depicts a block diagram of an example data structure for the resource data 140, according to an embodiment of the invention. The resource data 140 includes example records 250, 252, and 254, but in other embodiments any number of records with any appropriate data may be present. Each of the records 250, 252, and 254 includes a resource identifier field 256, a resource threshold field 258, a standard rate field 260, a billing rate increment field 262, and the current rate field 264, but in other embodiments more or fewer fields may be present. The resource identifier field 256 identifies a resource of the computer system 100 or a resources accessed via the network 130. The resource threshold field 258 indicates a threshold of use of the associated resource 256, which when exceeded by the process 220, the current billing rate 264 may be conditionally incremented by the billing rate increment 262. The standard rate 260 indicates the billing rate for the resource 256 if the resource threshold 258 is not exceeded.

FIG. 2C depicts a block diagram of an example data structure for the system data 142, according to an embodiment of the invention. The system data 142 includes records 280, 282, and 284, but in other embodiments any number of records with any appropriate data may be present. Each of the records 280, 282, and 284 includes a resource identifier field 286, a system threshold field 288, a system rate field 290, and a number of processes threshold field 295, but in other embodiments more or fewer fields may be present. The resource identifier field 286 identifies a resource of the computer system 100 or accessed via the network 130. The system threshold 288 indicates a threshold of system use of the resource 286. In response to the system threshold 288 being exceeded, the billing system 136 sets the current billing rate 264 for the resource 286 to the system billing rate 290, as further described below with reference to FIG. 3. The number of processes threshold 295 indicates a threshold of the number of the processes 134 that are executing using the resource 286. In response to the number of processes threshold 295 being exceeded, the billing system 136 may increment the current billing rate 264 by the rate increment 262, as further described below with reference to FIG. 4.

FIG. 3 depicts a flowchart of example processing for adjusting billing rates, according to an embodiment of the invention. Control begins at block 300. Control then continues to block 305 where the billing system 136 reads, retrieves, or determines usage data that indicates use of resources by individual processes 134 and for an aggregation of the processes 134, which reflects use of the resources by the computer system 100 as a whole. The usage data indicates the demand for the resources by each of the processes 134 and by an aggregation of all processes 134.

Control then continues to block 310 where the billing system 136 stores the read usage data in the usage data 138. Control then continues to block 312 where the billing system 136 sets the current resource to be the resource 286 in the first record in the system data 142. Control then continues to block 315 where the billing system 136 determines whether any resource 286 in the system data 142 remains unchecked by the logic of FIG. 3.

If the determination at block 315 is true, then all of the resources 286 in the system data 142 have not yet been checked by the logic of FIG. 3, so control continues to block 320 where the billing system 136 determines whether the system use of the current resource in the usage data 138 is greater than the system threshold 288 in the system data 142 for the associated resource 286. In the example usage data 138 the system use of the current resource is found in record 215.

If the determination at block 320 is true, then the system use of the current resource is greater than the system threshold 288, so control continues to block 325 where the billing system 136 sets the current rate 264 in the resource data 140 for all processes 134 using the current resource to be the system billing rate 290. Control then continues to block 330 where the billing system 136 sets the current resource to be the next resource in the system data 142. Control then returns to block 315, as previously described above.

If the determination at block 320 is false, then the system use of the current resource in the system data 142 is not greater than the system threshold 288 for the current resource, so control continues to block 340 where the billing system 136 checks the use of the current resource for individual processes, as further described below with reference to FIG. 4. Control then continues to block 330, as previously described above.

If the determination at block 315 is false, then all resources have been checked by the logic of FIG. 3, so control continues to block 399 where the logic of FIG. 3 returns.

FIG. 4 depicts a flowchart of further example processing for checking use of resources by the processes 134, according to an embodiment of the invention. Control begins at block 400. Control then continues to block 405 where the billing system 136 sets the current process to be the first process in the usage data 138. Control then continues to block 410 where the billing system 136 determines whether a process unchecked by the logic of FIG. 4 remains in the usage data 138.

If the determination at block 410 is true, then a process unchecked by the logic of FIG. 4 remains in the usage data 138, so control continues to block 415 where the billing system 136 determines whether the use of the current resource by the current process is greater than the resource threshold 258 for the current resource in the resource data 140. If the determination at block 415 is true, then the use of the current resource by the current process is greater than the resource threshold 258 for the current resource, so control continues to block 420 where the billing system 136 determines whether the number of processes 134 executing that are using the current resource (the number in the usage data 138) is greater than the threshold 295. If the determination at block 420 is true, then the number of processes executing that are using the current resource is greater than the threshold 295, so control continues to block 425 where the billing system 136 increments the current billing rate 264 by the billing rate increment 262 for the current resource 256 for all processes 134 that are using the current resource. Control then continues to block 430 where the billing system 136 sets the current process to be the next process in the usage data 138. Control then returns to block 410, as previously described above.

If the determination at block 420 is false, then the number of processes 134 executing using the current resource is not greater than the threshold 295, so control continues from block 420 to block 435 where the billing system 136 sets the current billing rate 264 for the current resource 256 for all processes to be the standard billing rate 260. Control then continues to block 430, as previously described above.

If the determination at block 410 is false, then no processes unchecked by the logic of FIG. 4 remain in the usage data 138, so control continues from block 410 to block 499 where the logic of FIG. 4 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
retrieving usage data for use of a resource by a plurality of processes; and
adjusting a billing rate for the use of the resource by the plurality of processes based on the usage data.

2. The method of claim 1, wherein the adjusting further comprises:
increasing the billing rate for the use of the resource if an amount of the use exceeds a threshold.

3. The method of claim 1, wherein the adjusting further comprises:
adjusting the billing rate based on a demand for the resource by one of the plurality of processes, wherein the usage data indicates the demand for the resource.

4. The method of claim 1, wherein the adjusting further comprises:
adjusting the billing rate based on a demand for the resource by an aggregation of all of the plurality of processes, wherein the usage data indicates the demand for the resource.

5. The method of claim 1, wherein the plurality of processes comprise a plurality of application servers.

6. The method of claim 1, wherein the plurality of processes comprise a plurality of partitions in a logically-partitioned computer.

7. The method of claim 1, wherein the resource comprises memory.

8. The method of claim 1, wherein the resource comprises a processor.

9. A signal-bearing medium encoded with instructions, wherein the instructions when executed comprise:
retrieving usage data for use of a resource by a plurality of processes, wherein the resource has a resource threshold, a resource billing rate, and a billing rate increment, wherein an aggregation of the plurality of processes has an associated system threshold and a system billing rate;
determining, based on the usage data, whether the aggregation of the plurality of processes uses the resource more than the system threshold; and
if the determining is true, setting the resource billing rate for the plurality of processes to be the system billing rate.

10. The signal-bearing medium of claim 9, further comprising:
if the determining is false, deciding, based on the usage data, whether one of the plurality of processes uses the resource more than the resource threshold, and incrementing the resource billing rate by the billing rate increment if the deciding is true.

11. The signal-bearing medium of claim 10, wherein the deciding further comprises:
deciding whether a number of the plurality of processes exceeds a threshold.

12. The signal-bearing medium of claim 9, wherein the plurality of processes comprise a plurality of application servers.

13. The signal-bearing medium of claim 9, wherein the plurality of processes comprise a plurality of partitions in a logically-partitioned computer.

14. The signal-bearing medium of claim 9, wherein the resource comprises memory.

15. The signal-bearing medium of claim 9, wherein the resource comprises a processor.

16. The signal-bearing medium of claim 9, wherein the resource comprises network bandwidth.

17. A method for configuring a computer comprising:
configuring the computer to retrieve usage data for use of a plurality of resources by a plurality of processes, wherein each of the plurality of resources has a resource threshold, a resource billing rate, and a billing rate increment, wherein an aggregation of the plurality of processes has an associated system threshold and a system billing rate;
configuring the computer to determine, based on the usage data, whether the aggregation of the plurality of processes uses the resource more than the system threshold; and
configuring the computer to set the resource billing rate for the plurality of processes to be the system billing rate if the determining is true.

18. The method of claim 17, further comprising:
configuring the computer to decide, based on the usage data, whether one of the plurality of processes uses the resource more than the resource threshold; and
configuring the computer to increment the resource billing rate by the billing rate increment if the deciding is true and the determining is false.

19. The method of claim 18, wherein the configuring the computer to decide further comprises:
configuring the computer to decide whether a number of the plurality of processes exceeds a threshold.

20. The method of claim 17, wherein the plurality of processes comprise a plurality of application servers.
